(19) United States
(12) Patent Application Publication
(10) Pub. No.: US 2014/0209635 A1
(43) Pub. Date: Jul. 31, 2014

(54) FROZEN BEVERAGE DISPENSER

(71) Applicants: Matthew Gates, Schertz, TX (US); Thomas L. Guy, San Antonio, TX (US); Craig Joy, San Antonio, TX (US)

(72) Inventors: Matthew Gates, Schertz, TX (US); Thomas L. Guy, San Antonio, TX (US); Craig Joy, San Antonio, TX (US)

(73) Assignee: FBD PARTNERSHIP, LP, San Antonio, TX (US)

(21) Appl. No.: 14/164,802

(22) Filed: Jan. 27, 2014

Related U.S. Application Data
(60) Provisional application No. 61/757,198, filed on Jan. 27, 2013.

(51) Int. Cl. A23G 9/04

(52) U.S. Cl. CPC A23G 9/045
USPC 222/144.5; 222/146.6

(57) ABSTRACT

An improved frozen beverage dispenser including one or more freezing/dispensing units and a refrigeration unit. The freezing/dispensing unit may include a freezing chamber, an integral accumulator, refrigeration valves and one or more dispensing nozzle. The refrigeration unit may include a refrigeration apparatus and a controller that includes integrated microprocessors running custom algorithms controlling the overall operation of the system.

### CROSS REFERENCE TO RELATED APPLICATIONS

This application claims priority to U.S. Provisional Patent Application Ser. No. 61/757,198, filed Jan. 27, 2013, the contents of which are incorporated herein by reference in its entirety.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate to frozen beverage dispensers, such as frozen carbonated beverage dispensers. Although these inventions can be used in numerous applications, the inventions will be disclosed in only a few of many applications for illustrative purposes.

2. Description of the Related Art

Conventional frozen beverage dispensers are unitary devices that include, in a single physical unit, all elements and components necessary to prepare, freeze and dispense a frozen beverage, such as a frozen carbonated beverage. In particular, such units typically include one or more freezing chambers for freezing a beverage, a beater and a beater motor, components for controlling the feeding of materials to the freezing chambers and the beater motor or refrigeration elements such as refrigeration valves, a condenser, a compressor and one or more fans.

Because of the number of components included in a conventional system, they tend to be physically large. This can create issues when the dispenser is to be used in a limited-space environment, such as the countertop of a convenience store or a small dispensing station in a restaurant. In particular, issues can arise where a frozen beverage dispenser is desired to be used and placed upon a countertop, such as may be encountered in a restaurant or bar setting or in a small convenience store.

Prior art approaches to addressing issues associated with the size impediments of conventional frozen beverage dispensers have varied. In one such approach, generally instructed in FIG. 1, the dispensing element of the frozen beverage dispenser is separated from the remainder of the system such that the freezing chamber, refrigeration system and other elements of the system are physically separated from the dispenser. One exemplary example of this approach is illustrated in FIG. 1.

Referring to FIG. 1, an exemplary prior art system 100 is shown that includes a main unit 110 below a countertop, a dispensing unit 120 above the countertop and lines 130 coupling the main unit 110 to the dispensing unit 120. In operation, a beverage is received into the main unit 110, frozen within a freezing chamber within the main unit 110 and dispensed, through lines 130 to the dispensing unit 110 and from the dispensing unit 110 into suitable drinking containers.

There are several limitations with this approach. Among them are the fact that the lines 130 carry frozen (or what is intended to be frozen) beverage. This is problematic in that if the ambient temperature is sufficiently high and if there is sufficient time between the dispensing of beverage services, the beverage in the lines 130 can convert from a frozen state to a non-frozen state, such that non-frozen beverage—or an undesirable beverage of indeterminate frozen status—will be dispensed. This results in either the dispensing of beverages of inconsistent and unknown quality (which is unsatisfactory) or the necessity of discarding an initial portion of each dispensed beverage, which is undesirable both in terms of creating disposal issues and in wasting material resulting in increased costs and expenses.

Another approach is to simply reduce the overall size of the frozen beverage dispenser such that the footprint of the unit is reduced. This approach has several disadvantages. As one example, as the size of the unit drops, the overall size of the freezing chamber drops, such that the volume of available frozen beverage for dispensing is reduced. For popular beverages, this can result in temporarily unavailability of a desired frozen beverage as the freezing chamber is emptied and has to be refilled with beverage and the beverage allowed freezing to the desired level. A further problem with the reduced size approach is that the refrigeration components—which can create noise and undesired air movement—continue to be positioned above the counter.

What is required, therefore, is a solution that provides a frozen beverage dispenser that can be used in small-space environments, provide a sufficient quantity of a desired frozen beverage of a consistently high quality, that minimizes undesired noise and air movement, and that can be suitably and economically manufactured.

Accordingly, the inventions disclosed and taught herein are directed to systems, methods, and apparatuses for providing a frozen beverage dispenser that addresses some or all of the issues set forth above.

### BRIEF SUMMARY OF THE INVENTION

The inventions disclosed and taught herein are generally directed, in certain embodiments, to an improved frozen beverage dispenser is a machine that dispenses frozen carbonated beverage dispenser including one or more freezing/dispensing units and a refrigeration unit. The freezing/dispensing unit may include a freezing chamber, an integral accumulator, refrigeration valves and one or more dispensing nozzle. The refrigeration unit may include refrigeration apparatus and a controller that includes integrated microprocessors running custom algorithms controlling the overall operation of the system.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1 illustrates an exemplary conventional frozen beverage dispenser 100 where the dispensing unit is separated from the main unit.

FIG. 2 illustrated an exemplary frozen beverage dispenser 200 constructed in accordance with certain teachings of this disclosure.

FIG. 3 illustrated additional details of the dispenser 200 of FIG. 2.

FIGS. 4A-4C illustrates one exemplary mode of operation of the dispenser 200.

FIG. 5 illustrates details of one exemplary embodiment of the freezing/dispensing unit 210 of FIG. 2.

FIGS. 6A and 6B illustrate additional details of the freezing/dispensing unit of FIG. 5.

FIGS. 7A and 7B illustrate details of an exemplary embodiment of the refrigeration unit 240 of frozen beverage dispenser 200.

FIG. 8 illustrates an alternative embodiment of an exemplary frozen beverage dispenser constructed in accordance with certain teachings of this disclosure.

FIGS. 9-12 illustrate alternate embodiments of dispensing systems constructed in accordance with certain teachings of this disclosure.

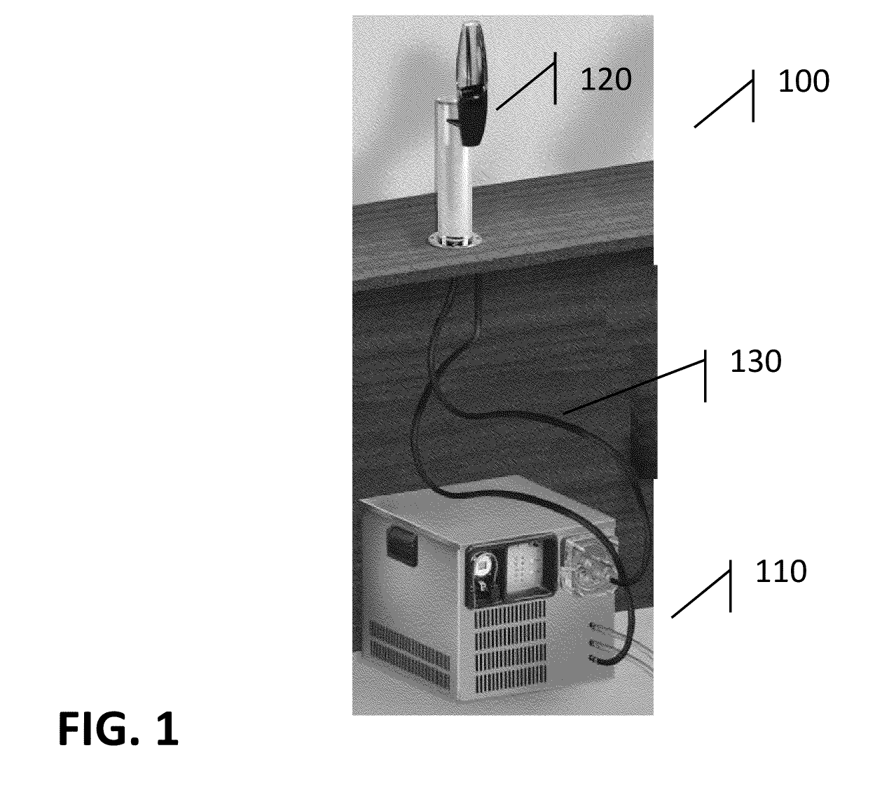

While the inventions disclosed herein are susceptible to various modifications and alternative forms, only a few specific embodiments have been shown by way of example in the drawings and are described in detail below. The Figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION OF THE INVENTION

The Figures described above and the written description of specific structures and functions below are not presented to limit the scope of what Applicant has invented or the scope of the appended claims. Rather, the Figures and written description are provided to teach any person skilled in the art to make and use the invention for which patent protection is sought.

Those skilled in the art will appreciate that not all features of a commercial embodiment of the invention are described or shown for the sake of clarity and understanding. Persons of skill in this art will also appreciate that the development of an actual commercial embodiment incorporating aspects of the present invention will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location and from time to time. While a developer's efforts might be complex and time-consuming in an absolute sense, such efforts would be, nevertheless, a routine undertaking for those of skill in this art having benefit of this disclosure.

The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally.

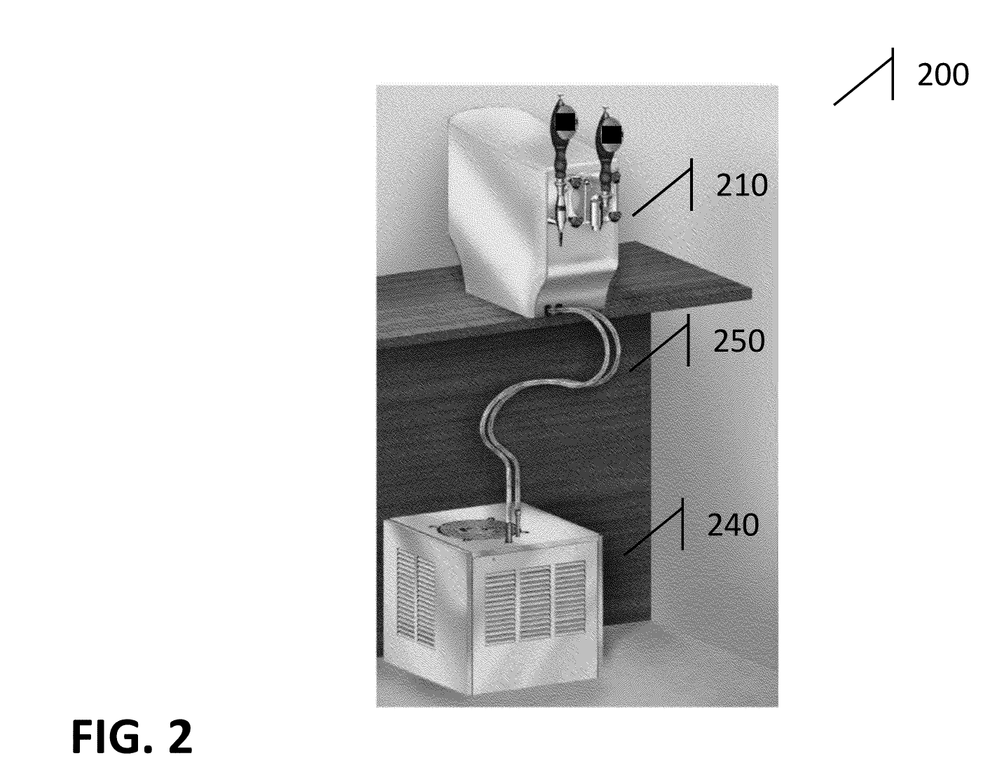

Turning to the figures in particular FIG. 2, an exemplary improved frozen beverage dispenser 200 is illustrated.

The improved frozen beverage dispenser includes a freezing/dispensing unit 210 and a separate, remote refrigeration unit 240. The remote refrigeration unit 240 is coupled to the freezing/dispensing unit 210 via refrigerant lines 250 and via control lines (not illustrated).

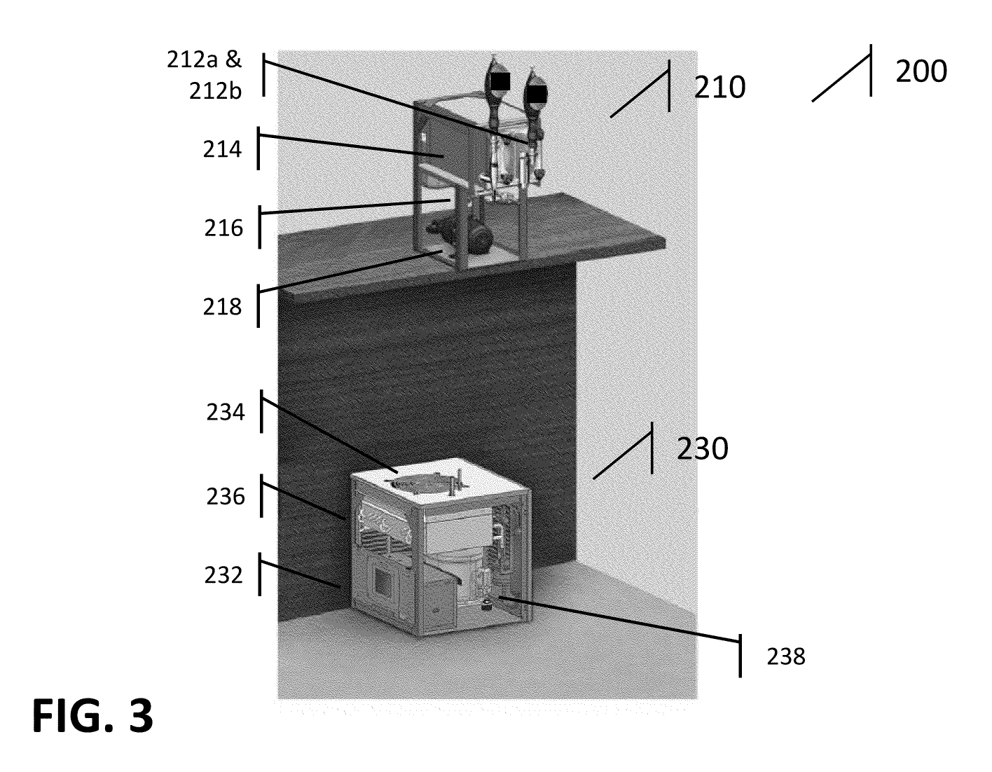

Additional details of the exemplary dispenser 200 are shown in FIG. 3.

Referring to FIG. 3, the freezing/dispensing unit 210 includes a liquid dispensing unit 210a and a frozen dispensing unit 212b. In operation a beverage, which may be a carbonated beverage, to be dispensed to the system is provided in a non-frozen form to the freezing/dispensing unit 210. A manifold in the freezing/dispensing unit 210 (not illustrated) may be used to provide some of the beverage (in a non-frozen form) to liquid dispensing nozzle 212a and some of the beverage to a freezing chamber or tank 214 where the beverage is frozen. Refrigeration valves 216 are included to control the freezing characteristics of the freezing tank 214. A beater element (unlabeled) may be positioned within the freezing tank 214 and an accumulator 218 may be coupled to the freezing tank and/or the lines feeding the accumulator 218.

The refrigeration unit 230 includes, in the illustrated example, a condenser fan 234, a condenser with condenser coils 236, a compressor 238 and a filter dryer (not labeled). The refrigeration in the illustrated example also includes an electronics box 232 that includes the electronics necessary to control the overall operation of the dispenser 200.

In operation, the refrigeration unit 238 provides compressed refrigerant to the freezing/dispensing unit 210 through the refrigerant supply line in connection 250 and receives heated and expanded refrigerant from the refrigeration/dispensing unit via the refrigerant return line in connections 250. The expanded refrigerant is then passed through the condenser 236 to release head, compressed by the compressor 238 and the compressed refrigerant is then provided to the freezing/dispensing unit 210 where it is converted a lower pressure fluid/gas through its passage through the refrigeration valves 216.

Control signals are provided by the electronics unit 232 to the refrigeration valves 216, the beater motor and (in some embodiments) to elements controlling the operation of the dispensing nozzles or various actuators to include when the frozen beverage is ready for dispensing, when the device needs to be cleaned, etc.

The connecting lines 250 can comprise a flexible line set and a wire look that allows signals to pass from the electronics unit 232 to the refrigeration valves 216 and the actuators described above.

While not illustrated FIG. 2 or 3 in optional accessories such as merchandisers for the freezing/dispensing unit 210, or a specialized base for the refrigeration 230 unit 230 may be integrated based desire.

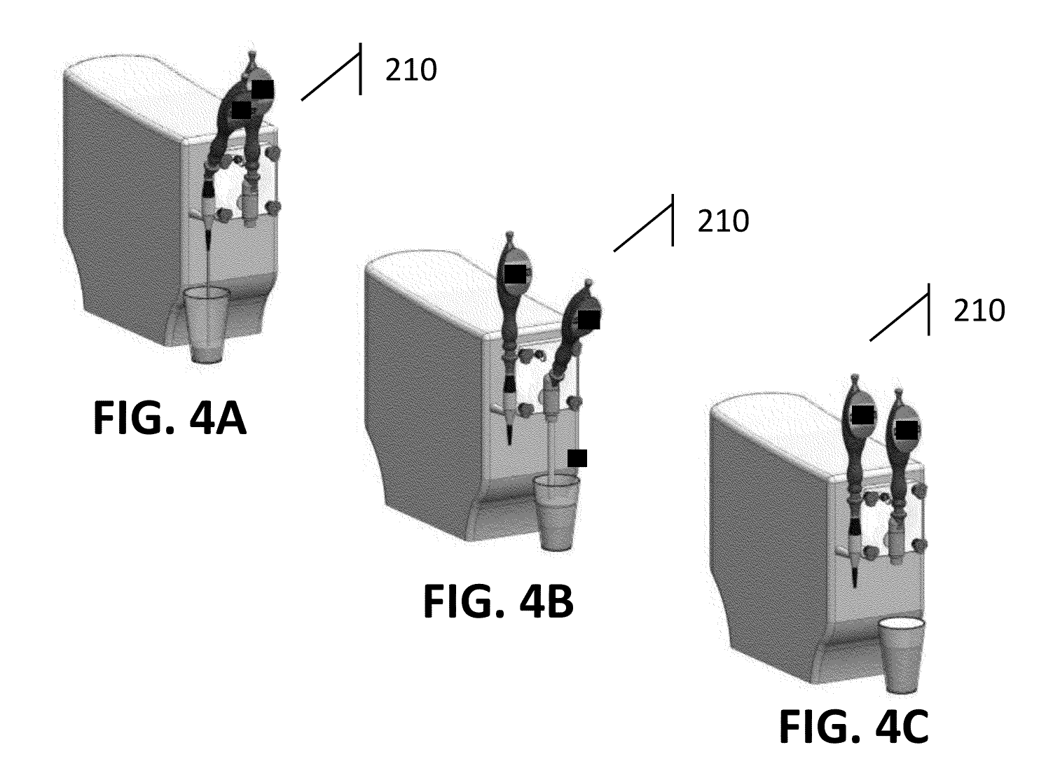

One beneficial aspect of the exemplary system 200 of FIG. 3 is that it allows for the beneficial dispensing of liquid beverages, frozen beverages, or a mixture of the two. This is generally shown in FIGS. 4A-4B.

Referring to FIG. 4A, the liquid dispensing nozzle may be actuated to dispense a liquid (non-frozen) version of the beverage supplied to the unit 210. As shown in FIG. 4B, the frozen dispensing nozzle may be actuated to dispense frozen beverage from the freezing chamber. The frozen beverage may be dispensed into an empty container (such that only frozen beverage will exist in the container) or it may be dispensed into a container that contains a liquid form of the beverage. This approach is shown in FIG. 4C where the resultant beverage includes a liquid base on the bottom and a frozen “head” on the top resulting from the dispensing of frozen beverage into a container including liquid. This mix of a liquid base and a frozen head is desirable for various types of beverages.

In the described example of FIGS. 4A-4C, the liquid beverage and the frozen beverage were the same. Alternate embodiments are envisioned where they differ. Still further embodiments are envisioned wherein there are multiple liquid nozzle dispensers. Such an arrangement could allow for the dispensing of a “neural” frozen beverage, such as a frozen sweet base from the frozen dispensing nozzle and various flavorings from the liquid nozzles. This would allow the operator of the exemplary dispenser 200 to custom blend a beverage of unique flavoring characteristics.

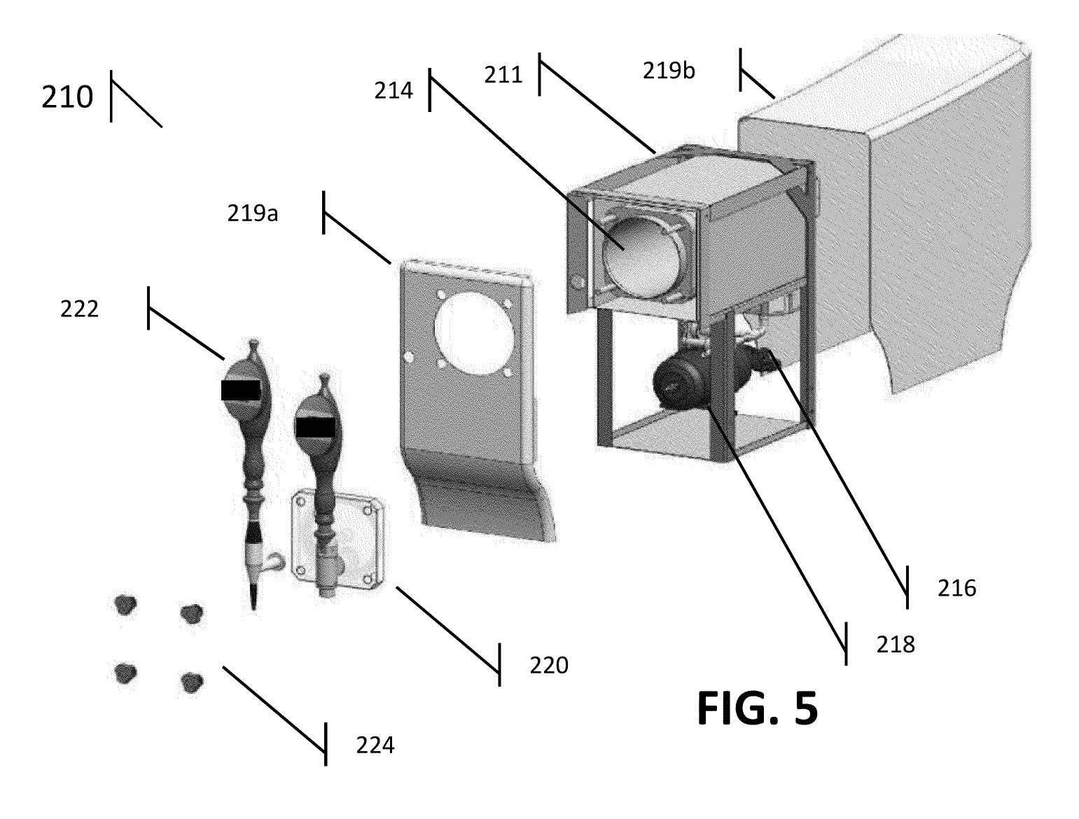

One aspect of the exemplary freezing/dispensing unit 210 disclosed herein is that it is efficient to manufacture and clean. This is shown generally in FIG. 5. Referring to FIG. 5, the unit 210 includes a main frame 211. Mounted on the main frame is the freezing chamber 214, the accumulator 218 and the expansion valves 216. Also mounted on the frame and (potentially) the freezing chamber 214 is a beater motor. A rear shroud 219b fits over the rear of the assembly.

A front shroud 219a fits over the front of the unit and may be removed easily for access to the interior of the assembly so that the accumulator 218 and the refrigeration valves 216 can be accessed, replaced or adjusted. The liquid and frozen dispensing nozzles 222 and 220 are affixed to the exterior of the front shroud 219a. Removable screws are used to couple the frozen dispensing nozzle 220 to the freezing chamber 212 such that the nozzle and associated faceplate can be removed for purposes of accessing and cleaning the freezing chamber and the dispensing nozzle 220.

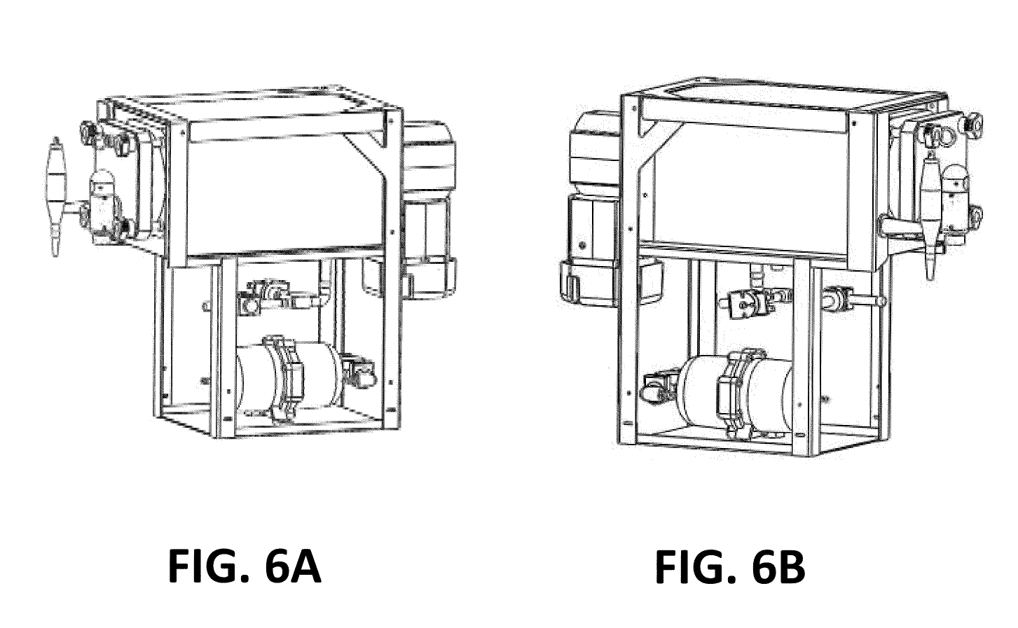

FIGS. 6A and 6B illustrate alternate views of the exemplary freezing/dispensing unit 210.

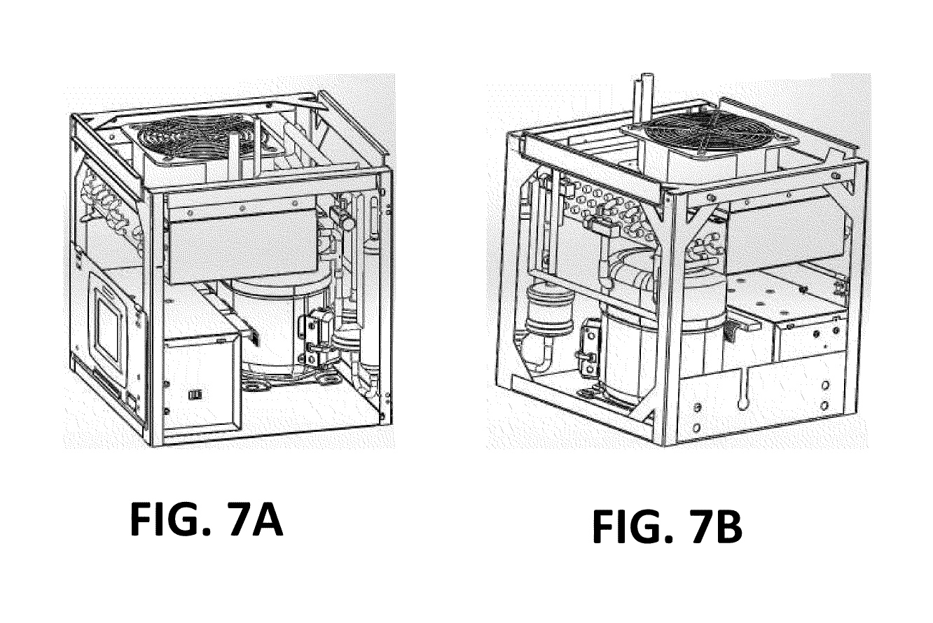

FIGS. 7A and 7B illustrate alternate views of the exemplary refrigeration unit 240.

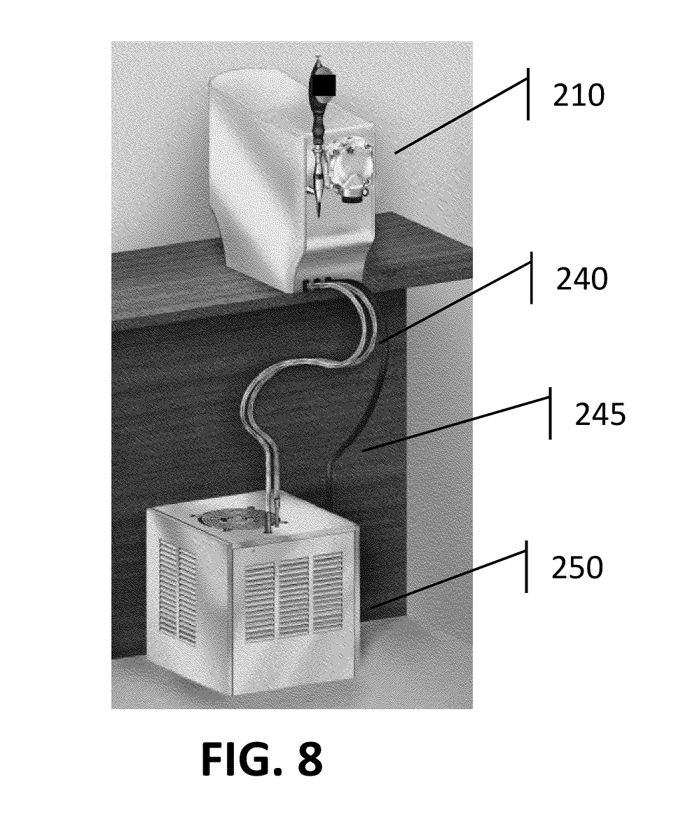

The above-described and illustrated embodiments are exemplary only and changes can be made without departing from the teachings of this disclosure. For example, the above-described examples use a manual nozzle 220 to control the dispensing of frozen beverage. Alternate embodiments are envisioned wherein a push-button automatic-dispenser is used to dispense the frozen beverage. Such an alternate embodiment is shown in FIG. 8 where a push-button frozen beverage dispenser is illustrated. In such an embodiment, an electronic controller (not illustrated) may be positioned within the freezing/dispensing unit to dispense a set quantity of frozen beverage in response to a depression of a button. FIG. 8 also illustrates the use of a separate electronic connection line 245 to couple the electronics unit within the refrigeration unit 250 to the refrigeration valves 216 valves and other controlled elements in the freezing/dispensing unit 210.

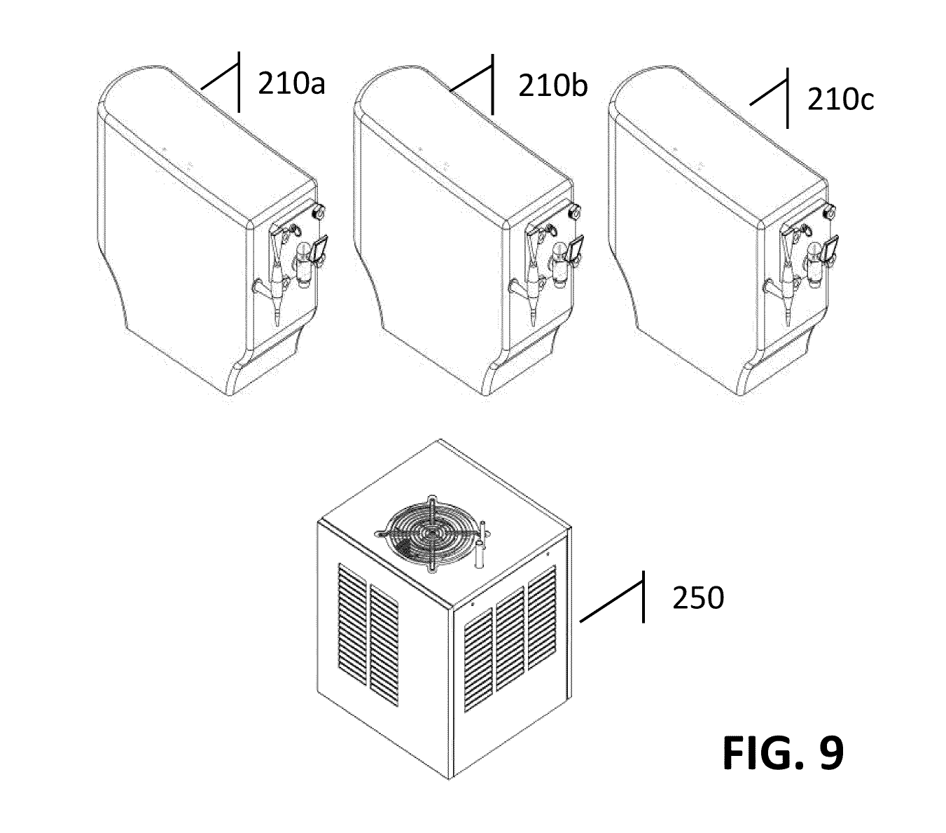

FIG. 9 illustrates yet another alternate embodiment. In this embodiment, a single refrigeration unit 250 provides refrigeration and control functionality to a plurality of freezing/refrigeration units 210. The connecting refrigeration and electronics control lines are not illustrated. This embodiment is of great potential benefit in that it can allow for the purchase and installation of the freezing/dispensing units at different times such that a user can begin with only a single unit 210 and build up as demand for the frozen beverage product is assessed and/or the ability to acquire additional units is achieved. This ability to start with a base system including a single refrigeration unit 250 and a single refrigeration unit 210 and expand to a system including multiple freezing/dispensing units is significant.

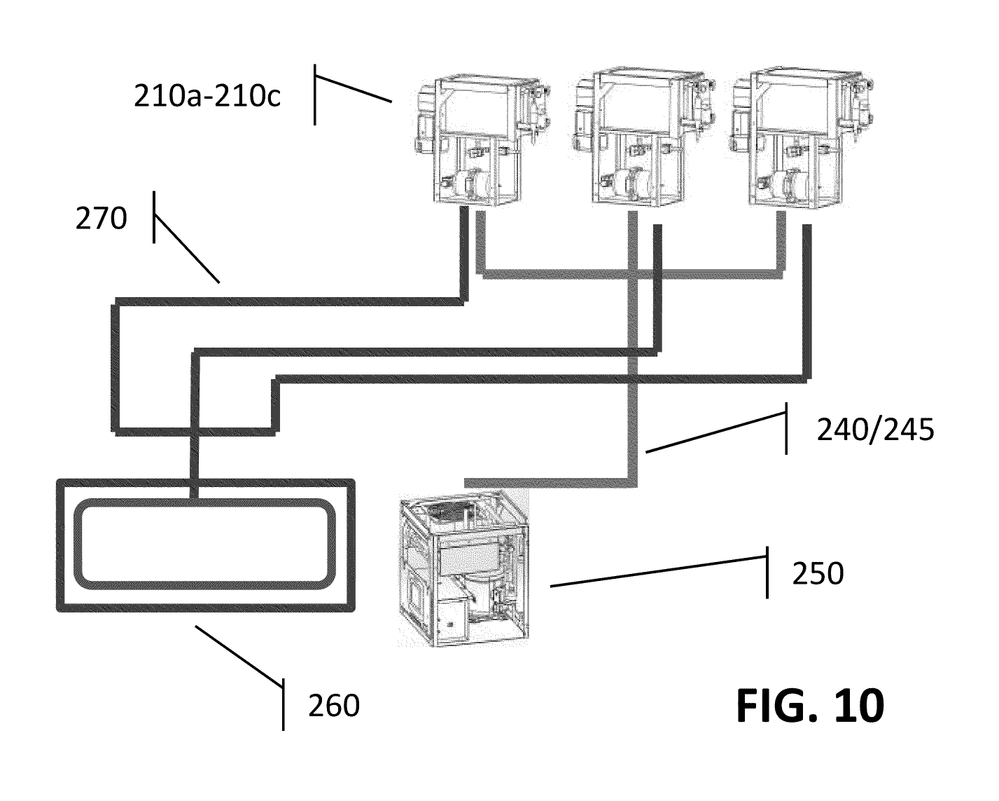

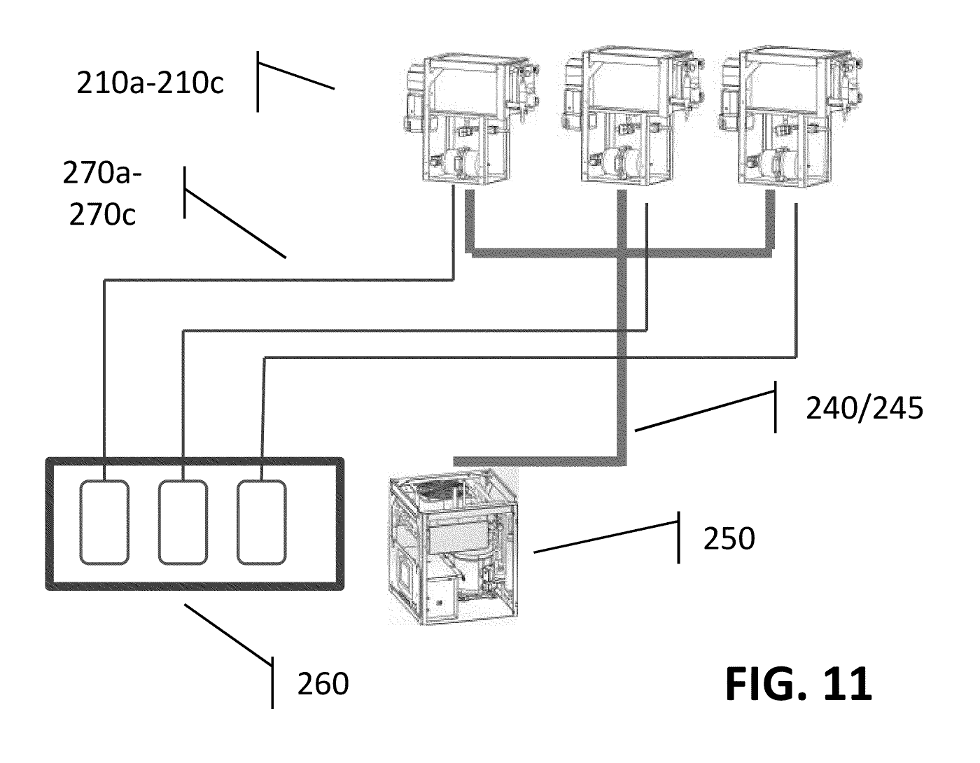

When multiple freezing/dispensing units are used, each unit can dispense the same beverage (as shown in FIG. 10) or each unit can dispense a different beverage (as shown in FIG. 11). As shown in both FIGS. 10 and 11, the beverage(s) to be dispensed can be provided from a single location 260, allowing for more efficient operation of the overall system.

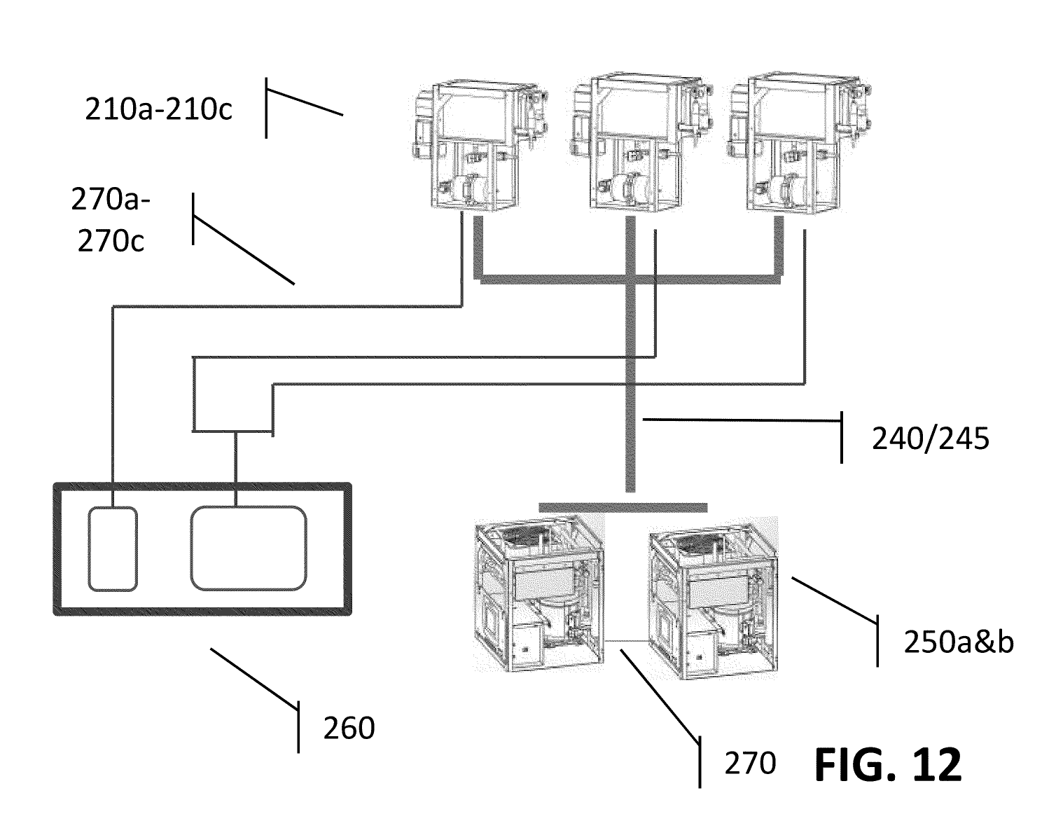

A still further embodiment of the present invention involves a modularized system that includes the use of multiple freezing/dispensing units 210 and multiple refrigeration units 250. One example of such a modularized system is shown in FIG. 12.

Referring to FIG. 12, three freezing/dispensing units 210a-210c are illustrated. The units are provided with beverages from a centralized beverage location 260. Notably, the flexibility of this approach is shown by the fact that two of the units 210b and 210c are dispensing the same beverage, while one of the units 210a is dispensing a different beverage. Two refrigeration units 250a and 250b provide/receive the refrigerant to and from the three units 210a and 210b. Both or one of the electronics box within the refrigeration units may control the overall system. An electronics link 270 may be used to allow communication between the controls within the refrigeration units to ensure that the control is appropriately handled or shared.

Use of the modular system enabled by the present invention has several advantages. For example, it allows for efficient load control, which can result in significant energy savings and/or reduce wear on equipment. In many establishments, there are peak times when a significant number of frozen beverages are being dispensed and other times when few are being dispensed, but they need to be available for dispensing. In such situations, one of the refrigeration units can be run during periods of relatively low dispensing, and both can be run during periods of high dispensing. This can allow for a more efficient selection of the components of the refrigeration unit such that the system is optimized for energy use purposes. Instead of having, a single refrigeration unit that is capable of handling peak demand but may run slightly inefficiently at lower demand, multiple refrigeration units can be used to ensure that the system runs at the most efficient level for a given demand.

A further advantage of the modular system of FIG. 12 is that it can provide safe “fail-overs” such that the overall system can continue to run. For example, assuming that the refrigeration units 250a and 250b are suitably sized, failure of one will not necessarily interfere with the ability of any of the freezing/dispensing units 210a-210c to continue to operate. Moreover, because the system of the present invention allows the placement of the refrigeration units 250a and 250b at a distance that is apart from the freezing/dispensing units 210a-210c (by distances ranging, for example from 48 inches up to and including 10-15 feet or more), repair or maintenance on one of the refrigeration units would not necessarily interfere with the dispensing of the frozen beverage(s)

A further potential benefit of the modular approach of the present disclosure, is that—in certain applications—it could potentially allow the freezing/dispensing units to take advantage of existing refrigeration systems that may exist in a given location that are used for running larger freezers or for air conditioning purposes. In such installations, a separate electronics controller could be provided to control the operation of the one or multiple freezing/dispensing units and communicate with the existing refrigeration system such that the flow and return of compressed and heated refrigerant to and from the freezing/dispensing unit(s) 210 can be controlled. An advantage of this approach is that it may allow for the optimized use of existing refrigeration capacity.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range or equivalent of the following claims.

What is claimed is:

1. An improved frozen beverage dispensing system comprising:
a first freezing/dispensing unit including: a freezing chamber; refrigeration valves coupled to control the flow of refrigerant to and from the freezing chamber; and at least a first dispensing nozzle for dispensing frozen beverage from the freezing chamber;
a first refrigeration unit coupled to provide refrigerant to and receive refrigerant from the first freezing/dispensing unit, the refrigerant unit including a compressor and a condenser;
first refrigeration lines coupled to the first freezing/dispensing unit and the first refrigerant unit, the first refrigerant lines having a length of greater than 48 inches;
a first liquid beverage dispensing unit; and
a first liquid beverage dispensing line coupled between the first liquid beverage dispensing unit and the first freezing/dispensing unit, the first liquid beverage dispensing line capable of transporting liquid beverage product from the first liquid beverage dispensing unit to the first freezing/dispensing unit.

2. The beverage dispensing system of claim 1 wherein the first freezing/dispensing unit further comprises a second dispensing nozzle for dispensing liquid beverage.

3. The beverage dispensing system of claim 2 wherein the first freezing/dispensing unit is configured such that the second nozzle is adapted to dispense a frozen version of a liquid beverage dispensed by the second nozzle.

4. The beverage dispensing system of claim 3 wherein the second nozzle is adapted to dispense a beverage different from the beverage used to form the frozen beverage.

5. The beverage dispensing system of claim 1 wherein the first freezing/dispensing unit is sized to fit on a countertop and the first refrigeration unit is configured to rest on a floor below the countertop.

6. The beverage dispensing system of claim 1 further comprising:
a second freezing/dispensing unit including: a freezing chamber; refrigeration valves coupled to control the flow of refrigerant to and from the freezing chamber; and at least a second dispensing nozzle for dispensing frozen beverage from the freezing chamber of the second freezing/dispensing unit; and
second refrigeration lines coupled to the second freezing/dispensing unit and the first refrigerant unit.

7. The beverage dispensing system of claim 6 wherein the second freezing/dispensing unit is adapted to dispense a frozen beverage different from a frozen beverage dispensed by the first freezing/dispensing unit.

8. The beverage dispensing system of claim 1 wherein the first freezing/dispensing unit includes a first housing and wherein the first refrigeration unit includes a second housing.

9. The beverage dispensing system of claim 1 further comprising a second refrigeration unit coupled to provide refrigerant to and receive refrigerant from the first freezing/dispensing unit, the second refrigerant unit including a compressor and a condenser and second refrigeration lines coupled to the first freezing/dispensing unit and the second refrigerant unit.

10. A beverage dispensing system comprising:
a refrigeration module including: (a) a housing and (b) a compressor, a condenser and a condenser fan located within the housing;
a first freezing/dispensing unit including: (a) a housing; (b) a first freezing chamber, refrigeration valves coupled to control the flow of refrigerant to and from the freezing chamber located within the housing and (c) at least one dispensing nozzle for dispensing frozen beverage from the first freezing chamber;
a second freezing/dispensing unit including: (a) a housing; (b) a second freezing chamber, refrigeration valves coupled to control the flow of refrigerant to and from the freezing chamber located within the housing and (c) at least one dispensing nozzle for dispensing frozen beverage from the second freezing chamber; and
refrigeration lines coupled to permit the flow of refrigeration fluid between the refrigeration module and the first freezing/dispensing unit and the flow of refrigeration fluid between the refrigeration unit and the second freezing/dispensing unit.

11. The beverage dispensing system of claim 10 further comprising a first liquid dispensing unit for dispensing liquid beverage to the first freezing/dispensing unit.

12. The beverage dispensing system of claim 11 wherein the first liquid dispensing unit is adapted for dispensing liquid beverage to the second freezing/dispensing unit.

13. The beverage dispensing system of claim 11 further comprises a second liquid dispensing unit for dispensing liquid beverage to the second freezing/dispensing unit.

14. The beverage dispensing system of claim 10 wherein the first freezing/dispensing unit further includes a second nozzle for dispensing liquid beverage.

15. A modular frozen beverage dispensing system comprising:
a refrigeration module including: (a) a housing and (b) a compressor, a condenser and a condenser fan located within the housing;
a first freezing/dispensing unit including: (a) a housing; (b) a first freezing chamber, refrigeration valves coupled to control the flow of refrigerant to and from the first freezing chamber located within the housing and (c) at least one dispensing nozzle for dispensing frozen beverage from the first freezing chamber; and
refrigeration lines coupled to permit the flow of refrigeration fluid between the refrigeration module and the first freezing/dispensing unit and the flow of refrigeration fluid between the refrigeration unit and a second freezing/dispensing unit.

16. The frozen beverage dispensing system of claim 15 wherein the first freezing/dispensing unit further includes an expansion valve.

17. The frozen beverage dispensing system of claim 15 wherein the first freezing/dispensing unit further includes an accumulator.

18. The frozen beverage dispensing system of claim 15 wherein the first freezing/dispensing unit further includes a dispensing nozzle for dispensing liquid beverage.

19. The frozen beverage dispensing system of claim 15 further including a liquid beverage dispensing unit for dispensing liquid beverage to the first freezing dispensing unit.

20. The frozen beverage dispensing system of claim 19 further includes a second freezing/dispensing nozzle for dispensing liquid beverage and wherein the second freezing/dispensing unit is adapted to dispense the liquid beverage from the liquid beverage dispensing unit in liquid form from the second dispensing nozzle and in frozen form from the at least one dispensing nozzle.
